(19) United States
(12) Patent Application Publication
(10) Pub. No.: US 2017/0086422 A1
(43) Pub. Date: Mar. 30, 2017

(54) DEVICE FOR DIRECTED ANIMAL TRAFFIC

(71) Applicant: GEA Farm Technologies GmbH, Bönen (DE)

(72) Inventors: Michael Schomaker, Oelde (DE); Heinz-Josef Beiwinkel, Rheda-Wiedenbrück (DE); Marcelo Barba, Alverskirchen (DE)

(21) Appl. No.: 15/312,043

(22) PCT Filed: May 21, 2015
(86) PCT No.: PCT/EP2015/061228

§ 371 Date: Nov. 17, 2016

(30) Foreign Application Priority Data
May 22, 2014 (DE) 10 2014 107 233.2

(51) Int. Cl. A01K 1/00; A01K 1/12

(52) U.S. Cl. CPC A01K 1/0023; A01K 1/12

(57) ABSTRACT

The invention relates to a device for directed animal traffic, comprising at least three sectors, a loop path, which is connected to the sectors, and, for each sector, a segment of the loop path that forms a transition region from the sector into the loop path, wherein the segment comprises a swinging gate, which allows an animal to enter the loop path from a sector and allows only one walking direction of the animal in the loop path, and a selection unit arranged after the swinging gate as viewed in the walking direction of the animal, by means of which selection unit the animal is directed into the sector or can walk further on the loop path.

No new matter is added.

### CROSS REFERENCE TO RELATED APPLICATIONS

This application is a national phase application under 35 U.S.C. §371 of PCT International Application No. PCT/EP2015/061228, filed May 21, 2015, which claims priority to German Application No. 10 2014 107 233.2 filed May 22, 2014, the disclosures of which are incorporated by reference herein.

### FIELD AND BACKGROUND OF THE INVENTION

The subject matter of the invention concerns a device for directed animal traffic, in particular of cows.

In conjunction with devices for the automatic milking of animals, such as, for example, cows, it is known that automatic or fully automatic milking devices are used. The automation preferably includes the use of a milking robot for milking an animal. It is known that a milking parlor which comprises the at least one milking robot is provided between two consecutive areas.

EP 0 619 702 A1 discloses a device for the automatic milking of animals. The device has a milking robot. Furthermore, the device has at least two enclosed areas in which animals can move freely, wherein the device has a system of doors, gates or similar devices which open in one direction such that the route and the direction on which or in which the animals can move toward the milking robot and away therefrom are determined. The areas in which the animals may be kept are arranged consecutively. The animal can pass from a first area of the consecutive areas via the milking robot into a second area of the consecutive areas. It is known from EP 0 619 702 A1 that further areas can also be provided, and therefore the animals can pass through the individual areas, with the effect of a round trip. The areas may be a field or a stall. The stall as such may in turn be divided into different areas. These areas may be, for example, feeding areas or lying areas for the animals.

U.S. Pat. No. 4,715,322 also discloses a device for directed animal traffic. The animals located in individual areas or sectors are directed to a milking parlor and away from the latter again by means of correspondingly controlled gates.

A further embodiment of a device for directed animal traffic is known from EP 0 582 350 A1. This device has at least three sectors. The sectors are directly connected to a milking parlor, specifically in such a manner that each sector is connected to the milking parlor via another sector, and therefore the milking parlor can be successively entered from one of the sectors by cows, which belong to a group and have yet to be milked, and can be departed from after the milking, wherein the cows are conducted into another sector. The sectors can be fields. FIGS. 13-16 of EP 0 582 350 A1 show that highly complicated movement routes are present depending on from which sector animals are intended to pass via the milking parlor into another sector. Furthermore, in the device known from EP 0 582 350 A1, there is the problem that, although animals can be guided from the field where they are located to the milking robot, they cannot be guided from there back to the same field again.

### SUMMARY OF THE INVENTION

Taking this as a starting point, the present invention is based on the objective of providing a device for directed animal traffic, which is of structurally simple design and is adapted to the animals and their behavior.

This object is achieved according to the invention by a device for directed animal traffic with the features of claim 1. Advantageous developments and refinements of the device according to the invention are the subject matter of the dependent claims. The features individually cited in the claims are combinable with one another in any technologically expedient manner and can be supplemented by explanatory substantive manner from the description, wherein further variant embodiments of the invention are presented.

The device according to the invention for directed animal traffic has at least three sectors. The sectors can be fields and/or stall areas, for example lying areas, feeding areas, etc. The sectors are connected to one another via a round passage. For this purpose, the round passage in each case has a segment which forms a transition region from a sector into the round passage. The segment has a swinging gate which permits entry of an animal from a sector into the round passage and only one direction of movement of the animal in the round passage. A selection unit is arranged downstream of the swinging gate, as seen in the direction of movement of the animal. The or an animal can be directed back or directed into the sector by means of the selection unit. The selection unit also makes it possible for the animal to be able to move further along the round passage.

Owing to the fact that selection units are provided, the animals can pass from one sector via the round passage into another sector. The animals move along the round passage, wherein the direction of movement may be, for example, in the clockwise direction. The term “round passage” should not necessarily be understood as meaning a passage which has a constant radius. There is also the possibility for the round passage to be formed by a polygon course.

Owing to the fact that a round passage is provided, the animals can be directed from one sector into another sector or conducted back again into the sector from which they come. This can take place directly by means of the selection unit or indirectly by the animal moving through the entire round passage.

Within an animal herd, animals have different ranks. The lower ranked animals also behave depending on the rank of the animal upon an encounter with a higher ranked animal. For example, in directed animal traffic which has crossing routes, there is the problem that the presence of a higher ranked animal may obstruct passage of the lower ranked animals, and therefore a jam may form in the crossing area of the routes of the animals. In order to avoid this, it is proposed, according to the refinement according to the invention of the device for directed animal traffic, that swinging gates are provided. Swinging gates firstly determine the direction of movement of the animal within the round passage. Secondly, filtering in of the animals into the round passage is permitted by the swinging gates.

The device according to the invention for directed animal traffic is advantageous in particular if said device is combined with at least one milking area. The milking area preferably has at least one automatic milking system (AMS) which preferably operates fully automatically. There is also the possibility for the milking area to comprise at least one semiautomatic or manual milking area. The milking area has at least one automatic milking system which the animals can find, in particular voluntarily, or driven or driven in groups of animals, and therefore the animals can pass back into the original sector after finding the milking area.

The invention as such also permits the grouping of animals. There is thus the possibility that animals of a group located in one sector can be supplied to a group of animals which is in a different sector. The animals do not have to be supplied under supervision of a person or the assistance of a person.

The milking area can preferably be part of the round passage. In such an advantageous refinement of the invention, all of the animals pass through the milking area, in which they can be milked.

A refinement of the device according to the invention for directed animal traffic is particularly preferred, in which a milking area is provided which is connected to the round passage. For this purpose, an entrance and an exit are provided. A selection unit is provided within the round passage, by means of which an animal is directed into the milking area or can move further along the round passage. A swinging gate is provided at the exit, said swinging gate permitting entry of an animal from the milking area into the round passage and only one direction of movement of the animal in the round passage.

The particular advantage of such a refinement of the device can also be considered that of the animals being able to become accustomed relatively rapidly to the animal traffic since the routes which they have to take are not complicated. Furthermore, the device has the advantage that selection unit and swinging gate essentially always appear the same components to the animals, and therefore simple conditioning of the animals is made possible. This has advantages in particular if the herd is to be partially or entirely interchanged or complemented by animals. Even low-ranked animals can follow the round passage or the animal traffic without being dependent on a lead animal.

According to yet another advantageous refinement of the invention, it is proposed that at least one region is provided which is connected to the round passage via an entrance, wherein a selection unit is provided in the round passage, by means of which an animal is directed into the at least one area or can move further along the round passage.

The at least one area can be a separation area into which predetermined animals are intended to pass. The at least one area may also be a treatment area in which an animal is intended to be treated. The at least one area may also be equipped with a milking facility, for example where animals whose milk is not marketable milk are intended to be brought.

A refinement of a device is preferred, in which the at least one area is connected to the round passage via an exit, wherein a swinging gate is arranged in the exit, said swinging gate permitting entry of an animal from the at least one area into the round passage and only one direction of movement of the animal in the round passage.

According to a further advantageous refinement, the selection units and/or the swinging gates are automatically actuable and controllable. For this purpose, the device has a control device. The control device can be part of a comprehensive herd management system which also permits the assignment of the animals to individual groups and/or sectors. The selection units and/or swinging gates preferably have means for identifying animals, wherein the means are connected by signal technology to the control device, and therefore fully automatic control of the device is made possible with simple means.

The invention is explained with reference to the preferred exemplary embodiments, which are illustrated in the drawing, without the subject matter of the invention being restricted to said specific refinements. In the drawing:

### BRIEF DESCRIPTION OF THE DRAWINGS

FIG. 1 shows a first exemplary embodiment of a device for directed animal traffic,

FIG. 2 shows, in enlarged form, a detail from the device according to FIG. 1, and

FIG. 3 shows a second exemplary embodiment of the device for directed animal traffic.

### DETAILED DESCRIPTION OF THE DRAWINGS

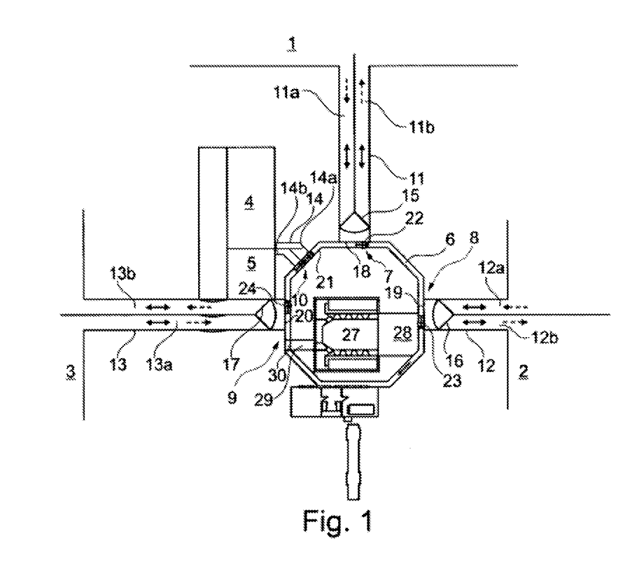

FIG. 1 illustrates a first exemplary embodiment of a device for directed animal traffic. The device comprises sectors 1-5 in which animals can be kept and can preferably move freely. The sectors 1, 2 and 3 are preferably fields. The sectors 4 and 5 are preferably separation areas, into which predetermined animals can pass. A round passage is denoted by the reference sign 6. The round passage 6 is connected to the sectors 1-5 via one passage 11-14 each. Animals can pass from a sector via the passage associated with the sector into the round passage and from there into another sector or the same sector. The sector 1 is connected, for example, to the round passage 6 via the passage 11.

In the exemplary embodiment illustrated according to FIG. 1, each passage 11-14 has a passageway 11a-14a and a passageway 11b-14b. The passageways 11a-14a and the passageways 11b-14b can be separated from one another by corresponding fences. It is apparent from the illustration in FIG. 1 that deflectors 15-17 are provided in the passages 11-13. A passageway 11a-13a or a passageway 11b-13b can be released or blocked by means of the deflectors 15-17. In the passageway 11a-14a, animals from a sector can pass into the round passage 6. The animals can pass from the round passage 6 via the same passageway 11a-14a into the particular sector 1-5. It is not necessary for the passageways 11a-11b; 12a-12b, 13a-13b; 14a-14b to be directly adjacent to one another. If it is determined that, for example, a passageway 11a can be passed through with difficulty or not at all by the animals because of rain or other events, the passageway 11a is blocked by the deflector 15 and the passageway 11b is opened up for the animals. There is also the possibility of configuring a passage in such a manner that the latter has a passageway in which animals can pass only from the sectors to the round passage, and a passageway in which animals can pass only from the round passage into a sector. This can be realized preferably by a corresponding position of the deflector in the passage. In the exemplary embodiment illustrated in FIG. 1, the passageways 11a-14a are opened up for the animals. The passageways 11b-14b are blocked by the corresponding deflectors 15-17. The animals pass from and to a sector via the particular passageway 11a-14a. It is described below that the animals use the particular passageway 11a-14a without the subject matter of the invention being restricted to this embodiment.

In each case one segment 7-10 forms a transition region from a sector 1-5 into the round passage 6. Each segment 7-10 has a swinging gate 18-21. Each swinging gate 18-21 permits entry of an animal from a sector via a passage into the round passage 6. The swinging gates 18-21 are arranged in such a manner that the direction of movement of the animal or of the animals in the round passage is predetermined. In the exemplary embodiment illustrated according to FIG. 1, the animals move in the clockwise direction. A selection unit 22-26 is in each case provided adjacent to the respective swinging gate 18-21, as viewed in the direction of movement of the animals. By means of the selection unit, an animal situated in the round passage can be directed either into a passage and therefore into a sector. Alternatively, there is also the possibility that the selection unit permits an animal to move further along the round passage 6.

The selection units 22-26 and/or the deflectors 15-17 are preferably equipped with animal identification means, which are not illustrated, and therefore the deflectors and/or the selection units can be activated or deactivated depending on individual animal specifications. This is not absolutely necessary. There is also the possibility for the deflectors 15-17 and the selection units 22-26 to be actuable manually or semi-automatically.

Owing to the fact that the swinging gates 18-21 together with the selection units 22-26 determine the direction of movement of the animal, substantially crossing-free animal traffic is achieved and therefore the formation of clusters at crossings is also avoided, this occurring in particular if a high-ranked animal is situated in the crossing area.

The device is substantially designed in such a manner that the sequence of swinging gate and selection unit substantially always appears identical to the animal depending on the location in the round passage, and therefore an animal can become accustomed rapidly to the round passage and the sequence.

In the exemplary embodiment illustrated in FIG. 1, a milking area 27 is provided. The milking area 27 can be a sector within the meaning of the invention. In the exemplary embodiment illustrated, the milking area 27 is surrounded by the round passage 6 and is connected to the latter via the entrance 28 and the exit 29. The entrance 28 to the milking area 27 is formed adjacent to the segment 8. This is not absolutely necessary. There is also the possibility for the entrance 28 to be assigned, for example, to the segment 7 or 9. The selection unit 23 is coupled to the entrance 28. The selection unit 23 is designed in such a manner that said selection unit creates three different route possibilities for an animal. Firstly, an animal from the round passage can continue its route along the round passage 6 by means of the selection unit 23. If the animal is intended to be milked, the animal is conducted out of the round passage 6 via the selection unit 23 into the entrance 28. Since the selection unit 23 is also assigned to the passage 12, an animal can pass from the round passage 6 into the passageway 12a via the selection unit 23.

The provision of a three-way selection unit 23 has the advantage that the outlay on apparatus and design is reduced. If the device is intended to be constructed from substantially identical parts, there is the possibility of providing a selection unit which permits only two routes, wherein then two such selection units are necessary.

If the animal in the milking area 27 has been milked, for example, by means of a milking robot, the animal leaves the milking area 27 via the exit 29. It is apparent from the illustration according to FIG. 1, that a swinging gate 30 through which the animal can enter the round passage 6 in a predetermined direction of movement is provided in the transition region between the round passage 6 and the exit 29.

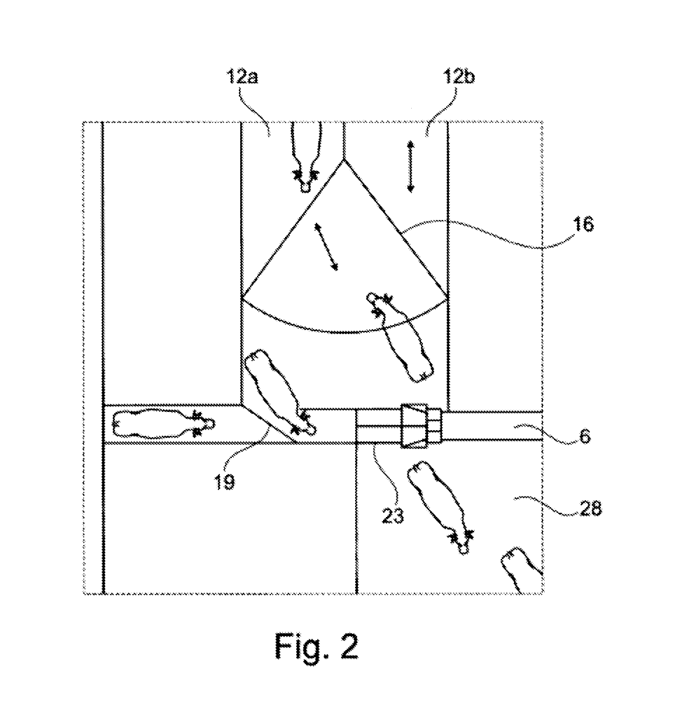

FIG. 2 illustrates the cooperation between the passage 12, the round passage 6 and the entrance 28 to the milking area in enlarged form. It is apparent from the illustration according to FIG. 2 that the passageway 12a is opened up by means of the deflector 16. The passageway 12b is blocked by means of the deflector 16. The animals pass via the passageway 12a from the corresponding sector to the round passage 6 and vice versa.

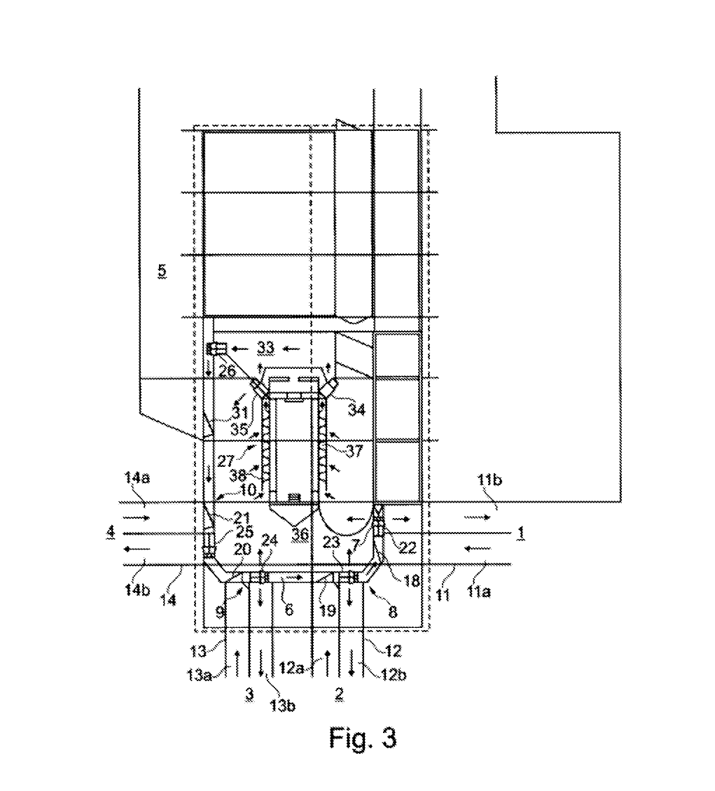

FIG. 3 shows a second exemplary embodiment of a device for directed animal traffic. The device comprises sectors 1-5. The sectors 1-4 are preferably fields. The sector 5 may be a separation area. A round passage is denoted by the reference sign 6. The sectors 1-4 are each connected via a passage 11-14. The sector 5 is directly connected to the round passage 6. Each passage 11-14 has a passageway 11a-14a. Animals from the relevant sector can pass through the passageways 11a-14a into the round passage 6. The animals can pass through the passageways 11b-14b from the round passage 6 into the respective sector 1-4. The sectors 1-4 can also be connected directly to the round passage 6.

One segment 7-10 in each case forms a transition region from a sector 1-4 into the round passage 6. Each transition region has a swinging gate 18-21. Each swinging gate 18-21 permits entry of an animal from a sector 1-4 via a passage 11a-14a into the round passage 6. The transition region from the sector 5 to the round passage 6 has a swinging gate 31. The swinging gates 18-21 and 31 are arranged in such a manner that the direction of movement of the animal or of the animals in the round passage 6 is predetermined. In the exemplary embodiment illustrated, the animals move counterclockwise, which is indicated by arrows in the round passage 6 of FIG. 3. A selection unit 22-26 is in each case provided adjacent to the respective swinging gate 18-21 and 26, as viewed in the direction of movement of the animals.

By means of the selection unit, an animal located in the round passage can either be transferred into the sector via a passage. Alternatively, there is also the possibility for the selection unit to permit the animal to move further along the round passage. Each selection unit has correspondingly swingable gates or the like through which the route for an animal is opened up or blocked.

The animals preferably bear identification means which can communicate with corresponding identification units provided on the selection units 22-26, and therefore the selection units are activated or deactivated depending on individual animal specifications, and directed animal traffic is thus achieved. This is not absolutely necessary. There is also the possibility for the selection units 22-26 to be actuable manually or semi-automatically.

The direction of movement of the animal or of the animals can be determined by the swinging gates 18-21 and 31 and the selection units 22-26. Crossing-free animal traffic is substantially achieved.

FIG. 3 shows a milking area 27. The milking area 27 has a plurality of milking places. The animals leave the milking area by the route 37 or 38 to the selection units 34 or 35. The selection units 34 and 35 are designed in such a manner that, depending on the individual animal specification, they can pass the animal either back into a waiting area 36 or into a collecting area 33. The collecting area 33 is part of the round passage 6. The animals pass out of the collecting area 33 into the round passage 6 via the selection unit 26.

It can be seen from the illustration according to FIG. 3 that the selection units 22-25 are designed in such a manner that the animals can pass out of a sector into the waiting area 36. Alternatively, the animals can walk along the round passage 6 or can be directed back into the sector. The selection units 22-25 therefore make it possible for the animals to walk along three different routes. This will be explained once again in more detail below by way of example in conjunction with an animal which is located, for example, in the sector 2. If an animal is located in the sector 2, the animal can pass via the passageway 12a and by swinging of the swinging gate 19 into a segment of the round passage 6. The animal is identified in particular as it enters the selection unit 23. The selection unit is correspondingly activated depending on the information about the animal, which information is stored in a database (not illustrated). If the information that the animal is authorized for milking is stored, only the route into the waiting area 36 is opened up in the selection unit. The further route along the round passage and the route to the passageway 12b are blocked. The animal located in the waiting area 36 can pass to the milking area 27. The milking area 27 preferably has a plurality of milking places. If the animal enters a milking place, the animal is milked. Subsequently, the animal passes, for example via the passage 38, into the selection unit 35. If the animal is intended to leave the milking area 27, the entrance to the collecting area 33 is opened up. Via the selection unit 26, the animal can leave the collecting area 33 either, for example, into the sector 5 or into the round passage 6. The animal can walk along the round passage. The animal passes the selection unit 25 here. If the animal has been recognized in the selection unit 25, the selection unit 25 is activated in accordance with the data stored regarding the animal. If it is on file that the animal can now pass into the sector 4, the entrance to the sector 4 is activated in the selection unit 25, and therefore the animal can pass from the round passage 6 into the passageway 14b.

If the animal which has left the sector 2 and is in the selection unit 23 is not yet authorized for milking, the entrance to the milking area 27 is blocked and, for example, the entrance to the passageway 12b is opened up such that the animal can be guided back into the sector 2. If the animal which has left the sector 2 via the selection unit 23 is intended to pass to the sector 1, the further route in the round passage is opened up by the selection unit 23. The animal then proceeds to enter the selection unit 22 and passes via the passageway 11b into the sector 1.

The selection units 22-26 are preferably of identical design, and therefore the outlay on design and apparatus for realizing the device for directed animal traffic can be kept low. The device according to the invention also has the advantage that the number of sectors can be extended within the scope of what is practical without complicating the route for the animals.

1. A device for directing animal traffic, comprising:
at least three sectors, a loop passage connected to the sectors and each sector includes a segment of the loop passage, which segment forms a transition region from a sector into the loop passage; and each segment includes an animal entry swinging gate opening into the loop passage and permitting only one direction of movement of the animal in the loop passage; and
a selection unit arranged downstream of at least one of the swinging gates, as viewed in the direction of movement of the animal, to direct an animal into the sector or further along the loop passage.

2. The device of claim 1, and further comprising:
a milking area that is at least part of the loop passage.

3. The device of claim 1, and further comprising:
a milking area connected via an entrance and an exit to the loop passage, and wherein the selection unit is provided in the loop passage, to direct an animal into the milking area or further along the loop passage, and at least one of the swinging gates is arranged in the exit, to permit entry of an animal from the milking area into the loop passage and provide only one direction of movement of the animal in the loop passage.

4. The device of claim 1, and further comprising:
a control device to control the selection units and/or the swinging gates.

5. The device of claim 4, and further comprising:
an animal detection device in communication with the control device to control the selection units and/or the swinging gates.
